(19) United States
(12) Patent Application Publication
(10) Pub. No.: US 2003/0027538 A1
(43) Pub. Date: Feb. 6, 2003

(54) Receiving apparatus and a receiver system having the receiving apparatus

(76) Inventors: Hiroshi Masumoto, Kanagawa-ken (JP); Tsuneo Suzuki, Kanagawa-ken (JP)

Correspondence Address: Finnegan, Henderson, Farabow,, Garrett & Dunner, L.L.P., 1300 I Street, N.W., Washington, DC, 20005-3315, US

(21) Appl. No.: 10/205,389

(22) Filed: Jul. 26, 2002

(30) Foreign Application Priority Data
Jul. 27, 2001 (JP) 2001-228199

(51) Int. Cl. H04B 1/06; H04B 7/00

(52) U.S. Cl. 455/234.1; 455/234.2; 455/232.1

(57) ABSTRACT

A receiving apparatus comprising a gain control amplifier, a gain controller and a level detection circuit. The gain controller controls a gain of the gain control amplifier. The level detection circuit specifies a range of strengths of received signals based on a signal coupled to an input of the gain control amplifier. The gain controller controls the gain of the gain control amplifier based on the range of the strengths of the received signals.

### CROSS REFERENCE TO RELATED APPLICATIONS

This application claims the benefit of priority from prior Japanese Patent Application P2001-228199 filed on Jul. 27^{th}, 2001; the contents of which are incorporated by reference herein.

### RELATED

System consistent with this invention relates to a receiving apparatus for controlling a gain by an auto gain control (AGC) amplifier. In one embodiment, this receiving apparatus is used, for example, by a wireless LAN card or the like, for which a high-speed response is required for performing data transfer with many unspecified items.

### BACKGROUND OF THE ART

In receiving apparatus for controlling a gain by a gain control amplifier (e.g., AGC amplifier), heretofore, a received electric field strength has been specified by using a wireless signal strength indicator (RSSI) analog circuit. The RSSI analog circuit normally specifies a received electric field strength based on a gain control voltage, a demodulation output of the AGC amplifier controlled by the gain control voltage and a state of an attenuator.

FIG. 1 shows an example of a receiving apparatus including an AGC amplifier. FIG. 2 shows an example of an intermediate frequency (IF) detector of FIG. 1.

A wireless wave received through an antenna 1 or an antenna 8 is amplified by a low noise amplifier (LNA) 2, passed through a band pass filter (BPF) 3, and then converted into an IF signal by a down converter (DC) 4. At the BPF 3, unnecessary noise contained in the received wireless wave is removed.

Generally, considering a system such as a wireless LAN, a wireless wave of a 2.4 GHz band is used for a system compliant with IEEE 802.11b, and a wireless wave of a 5 GHz band is used for a system compliant with IEEE 802.11a. Frequencies of these wireless waves are converted to about 500 MHz by the DC (or mixer) 4. A first local frequency oscillator 5 generates an antenna input frequency f of 0±500 MHz so as to set an output signal of the DC 4 to 500 MHz. Thus, the BPF 3 becomes a filter mainly for a 2.4 GHz or 5 GHz band, and a BPF 6 becomes a filter mainly for a 500 MHz band. The BPF 6 may be called a channel selection filter because of a role thereof to remove an adjacent channel signal.

An output signal of the BPF 6 is inputted to an AGC amplifier 7. At the AGC amplifier 7, a gain is controlled to maintain a signal waveform in a linear shape. Output signals of the AGC amplifier 7 are passed through an orthogonal demodulation circuit, comprising mixers 10 and 11, a 90° phase shifter 12, and a second local oscillator 13, accordingly becoming I and Q signals orthogonal to each other.

The I and Q signals are maintained in linear shapes by controlling a gain of the AGC amplifier 7. In the wireless LAN system, a dynamic range necessary for receiving a wireless wave is about 80 dB. If attenuation (variable range of gain) of the LNA 2 is 20 dB, then the gain of the AGC amplifier 7 may need a variable range of about 60 dB.

The I and Q signals that have been outputted are converted into digital signals respectively by AD converters 14 and 15, and processed by a base band circuit 16.

In order to control the gain of the AGC amplifier 7, it is necessary to know a received electric field strength. In initial state, the gain of the AGC amplifier 7 is fixed. In a normal state, however, it is controlled according to sensitivity of the wireless LAN system.

When a received wireless wave has a high electric field strength, an input signal of each of the AD converters 14 and 15 may initially exceed a dynamic range thereof. The dynamic range of each of the AD converters 14 and 15, which is necessary for a function as a receiving apparatus, is about 80 dB. Generally, however, the dynamic ranges of the AD converters 14 and 15 are not set so wide.

The dynamic ranges of the AD converters 14 and 15 are decided based on quantization noise of the AD converters 14 and 15, an S/N ratio and signal voltages of all channels.

According to IEEE802.11a, orthogonal frequency division multiplexing (OFDM) is performed, and 64 quadrate amplitude modulation (QAM) is used at a maximum. This system has a signal band of 16.6 MHz/2=8.3 MHz, a sub-channel band of 300 kHz, and 52 channels.

Thus, 8-bit AD converters 14 and 15 are necessary for IEEE802.11a, and 6-bit AD converters 14 and 15 are necessary for IEEE802.11b.

In the system shown in FIG. 1, an IF detector 9 is present, while the RSSI analog circuits are not present. The IF detector 9 detects whether a received signal is saturated or not. If saturated, the IF detector 9 immediately transmits this information to a gain controller 17. Upon having received the information indicating the saturation of the received signal, the gain controller 17 sends a control signal to the LNA 2, and reduces a gain of the LNA 2 by about 20 dB (gain is changed from “GA1” to “GA1-20”).

For example, assuming that sensitivity of the receiving apparatus is 90 dBm, and that a level of a received wireless wave for operating the IF detector 9 is −30 dBm, when a wireless wave of ≧−30 dBm to <−10 dBm is first received, the IF detector 9 is set operative. Following this, the gain controller 17 reduces the gain of the LNA 2 by one stage (20 dB). As a result, a state after the change of the gain of the LNA 2 becomes substantially equal to a state where a level of a received wireless wave is ≧−50 dB to <−30 dBm before the gain of the LNA 2 is changed, thus making the IF detector 9 not perable.

Thus, by considering the variable ranges of the gains of the LNA 2 and the AGC amplifier 7, it is possible to provide a receiving apparatus of a wireless LAN system, which is capable of covering a total of, for example, −90 dBm to −10 dBm.

However, as described above, the dynamic ranges of the AD converters 14 and 15 are still below 60 dB. For example, in IEEE802.11b, a 6-bit AD converter is used, and a dynamic range thereof is about 36 dB. In IEEE802.11a, an 8-bit AD converter is used, and a dynamic range thereof is about 48 dB.

In addition, assuming that 20 dB is necessary for an S/N ratio when a signal level is minimum, practically, dynamic ranges of the 6-bit and 8-bit AD converters become about 16 dB and 28 dB, respectively.

Therefore, if the variable range of the gain of the AGC amplifier 7 is 60 dB, in order to know an electric field strength of a received wireless wave (received signal), it is necessary to measure a level (antenna input level) of the received wireless wave by changing the gain of the AGC amplifier 7, four times in the 6-bit AD converter, and three times in the 8-bit AD converter.

The IF detector 9 is made not operative when the level of the received wireless wave is in a range of a value equal to/higher than sensitivity of the receiving apparatus (e.g., −90 dBm) to below a value (e.g., −30 dBm) obtained by adding 60 dB to this value of −90 dBm. In this case, the range is divided into a plurality of detection ranges, I and Q signals as demodulation outputs are measured a plurality of times, and then determination is made as to which of the plurality of detection ranges the level of the received wireless wave belongs to.

In the case of IEEE802.11b, a system such as Gaussian frequency shift keying (GFSK) or phase shift keying (PSK) of a direct sequence spread spectrum (DS-SS) is used. In this case, because of equality in amplitude among codes, even if a demodulation waveform is saturated, a received signal can be demodulated as long as phase information is supplied.

Accordingly, if the AD converters 14 and 15 for receiving the I and Q signals are 6-bit types, and the dynamic ranges thereof are 16 dB, then a level of the received signal is measured to determine which of the detection ranges of 60 dB it belongs to, while gradually reducing the gain of the AGC amplifier 7, thus making it possible to receive the signal even before correct gain setting of the AGC amplifier 7.

As a result, for example even before a gain of the AGC amplifier 7 is set, phase information can be reproduced. Even in the conventional method shown in FIG. 1, a sufficient function can be achieved as the receiving apparatus of IEEE802.11b. However, for the RSSI, gain setting must be carried out correctly.

On the other hand, in the case of IEEE802.11a, the orthogonal frequency division multiplexing (OFDM) is employed, and the 64 QAM is used at a maximum. Accordingly, a function is insufficient as the receiving apparatus unless not only phase information but also amplitude information can be accurately reproduced. Consequently, no signals can be received before correct gain setting of the AGC amplifier 7. In the receiving apparatus of IEEE802.11a, the gain of the AGC amplifier 7 must be strictly set.

FIG. 3 shows a relation between an antenna input level and an output signal of an IF detector in the conventional receiving apparatus compliant with IEEE802.11a, and shows a plurality of detection ranges (gain setting sections of AGC amplifier 7) present in a range of >−90 dBm to <−30 dBm.

In order to increase the strength of the received wireless wave more, the receiving apparatus selects one wireless wave having a high strength among wireless waves received through, for example, two antennas 1 and 8 shown in FIG. 1, by a switch circuit SW. This structure is called an antenna diversity structure. Accordingly, to measure the level of the received signal, the antennas 1 and 8 must be switched to measure each electric field strength.

FIG. 4 shows a timing chart of the conventional circuit compliant with IEEE802.11a. In the timing chart, first, an electric field strength of a wireless wave received by the antenna 1 is measured. For example, for the received signal, a first round of AGC voltage switching and IQ level detecting is carried out, and then a second round of AGC voltage switching and IQ level detecting is carried out. Subsequently, a third round of AGC voltage switching and IQ level detecting is carried out, and then the antenna is switched to another.

Then, an electric field strength of a wireless wave received by the antenna 8 is measured. For example, for the received signal, a first round of AGC voltage switching and IQ level detecting is carried out, and then a second round of AGC voltage switching and IQ level detecting is carried out. Subsequently, a third round of AGC voltage switching and IQ level detecting is carried out, and then the antenna is switched to another.

Then, a gain of the AGC amplifier 7 is set based on the electric filed strengths of the wireless waves received by the antennas 1 and 8. In this case, time before final setting of the gain of the AGC amplifier 7 is about 7.8 μs.

The above-described time 7.8 μs is broken down into time 0.4 μs for switching (setting) an AGC voltage, time 0.8 μs for detecting IQ levels, and time 0.1 μs for switching the antenna.

In IEEE802.11a, in a first period of 0.8 μs×10=8 μs, the gain of the AGC amplifier 7 should be set, and synchronization must be completed. Accordingly, because at least 2.4 μs or more needs to be secured as time for synchronization, if about 1.6 μs is necessary from gain setting completion of the AGC amplifier 7 to starting of synchronization, then the gain setting of the AGC amplifier 7 must be terminated within 4 μs.

However, in the conventional method, as shown in FIG. 13, since about 7.8 μs is necessary at a maximum for the gain setting of the AGC amplifier 7, a problem is inherent, which may result in not sufficiently meeting specifications of IEEE802.11a.

### SUMMARY

According to one embodiment of the present invention, a receiving apparatus of the present invention comprises: a gain control amplifier; a gain controller for controlling a gain of the gain control amplifier; and a level detection circuit for specifying a range of strengths of received signals based on an input signal of the gain control amplifier, wherein the gain controller controls the gain of the gain control amplifier based on the range of the strengths of the received signals.

The level detection circuit may detect whether a strength of the input signal is equal to/higher than first, second and third levels or below. The level detection circuit may also detect which of first, second and third ranges the strength of the input signal belongs to. The level detection circuit has a function of detecting whether the strength of the input signal is equal to/higher than at least two levels or below.

The level detection circuit may comprise a first IF detector for receiving the input signal and detecting whether the strength of the input signal is equal to/higher than a fixed level or below, a first amplifier for receiving the input signal, the first amplifier having a fixed gain, and a second IF detector for receiving an output signal of the first amplifier and detecting whether a strength of the output signal of the first amplifier is equal to/higher than the fixed level or below.

The level detection circuit may comprise a second amplifier having the fixed gain for receiving the output signal of the first amplifier, the second amplifier having the fixed gain, and a third IF detector for receiving an output signal of the second amplifier and detecting whether a strength of the output signal of the second amplifier is equal to/higher than the fixed level or below.

In accordance with another embodiment of the present invention, a wireless LAN card of the present invention includes the above-described receiving apparatus.

In accordance with another aspect of the present invention, a receiving method of the present invention comprise: setting at least two levels; specifying a range of strengths of received signals by substantially simultaneously detecting whether strengths of the input signals of a gain control amplifier are equal to/higher than at least the two levels or below; and controlling a gain of the gain control amplifier based on the range of the strengths of the received signals.

Other features, and advantages of the present invention will become apparent from the following detailed description. It should be understood, however, that the detailed description and specific examples, while indicating embodiments of the invention, are given by way of illustration only, since various changes and modifications within the spirit and scope of the invention will become apparent to those skilled in the art from this detailed description. The scope of the invention is defined by the claim.

### BRIEF DESCRIPTION OF THE DRAWINGS

A more complete appreciation of the present invention and many of its attendant advantages will be readily obtained by reference to the following detailed description considered in connection with the accompanying drawings, in which:

FIG. 1 is a circuit diagram showing a receiving apparatus.

FIG. 2 is a circuit diagram showing an example of an IF detector of FIG. 1.

FIG. 3 is a graph showing a level detected output of the IF detector of FIG. 2.

FIG. 4 is a timing chart showing an operation of the receiving apparatus of FIG. 1.

FIG. 5 is a circuit diagram consistent with this invention, showing a receiving apparatus according to a first embodiment of the present invention.

FIG. 6 is a circuit diagram consistent with this invention showing an example of a level detection circuit of FIG. 5.

FIG. 7 is a circuit diagram showing a specific example of the IF detector consistent with this invention of FIG. 6.

FIG. 8 is a view consistent with this invention, showing a relation between an input level of each IF detector of FIG. 6 and an output voltage.

FIG.9 is a relation between the antenna input level and the output signal consistent with this invention.

FIG. 10 is a timing chart consistent with this invention showing an operation of the receiving apparatus of FIG. 5.

FIG. 11 is a circuit diagram showing a level detection circuit according to a second embodiment of the present invention.

FIG. 12 is a graph showing a relation between an input level of each IF detector of FIG. 11 and an output voltage.

FIG. 13 is a circuit diagram showing a level detection circuit according to a third embodiment of the present invention.

FIG. 14 is a graph consistent with this invention showing a relation between an input level of each IF detector of FIG. 13 and an output voltage.

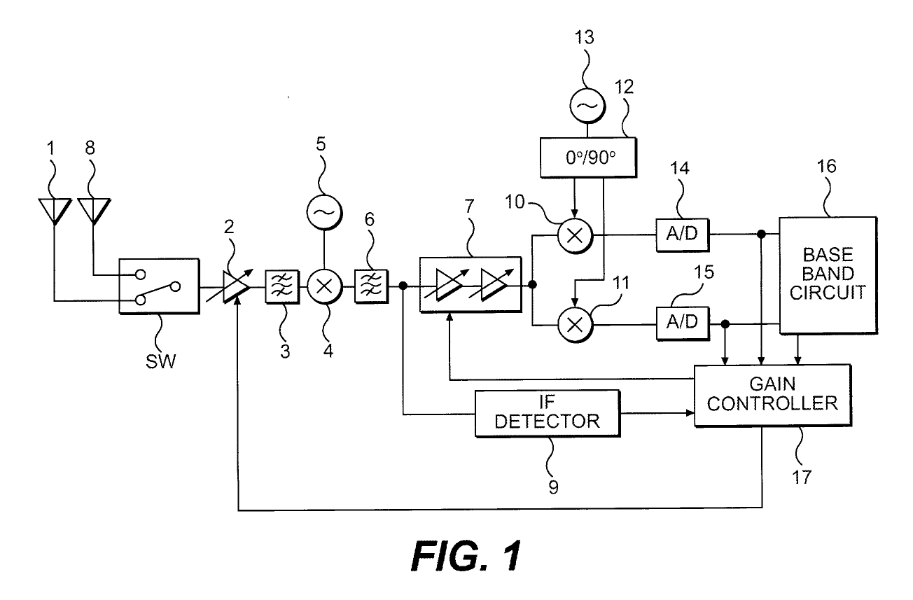

### DETAILED DESCRIPTION OF THE EMBODIMENTS

Detailed description will be made for a receiving apparatus of the present invention with reference to the accompanying drawings.

In one embodiment of the invention, receiving apparatus has a feature in that an AGC amplifier is provided, a gain thereof being adjusted in order to prevent a received signal from being distorted, and that a level detection circuit for detecting a level of the received signal inputted to the AGC amplifier is provided with a function of detecting signal strengths of optional two or more levels. Consequently, which range of preset levels the strength of the received signal is set in can be determined immediately after a start of receiving, and it is accordingly possible to sufficiently meet specifications of, for example, IEEE802.11a.

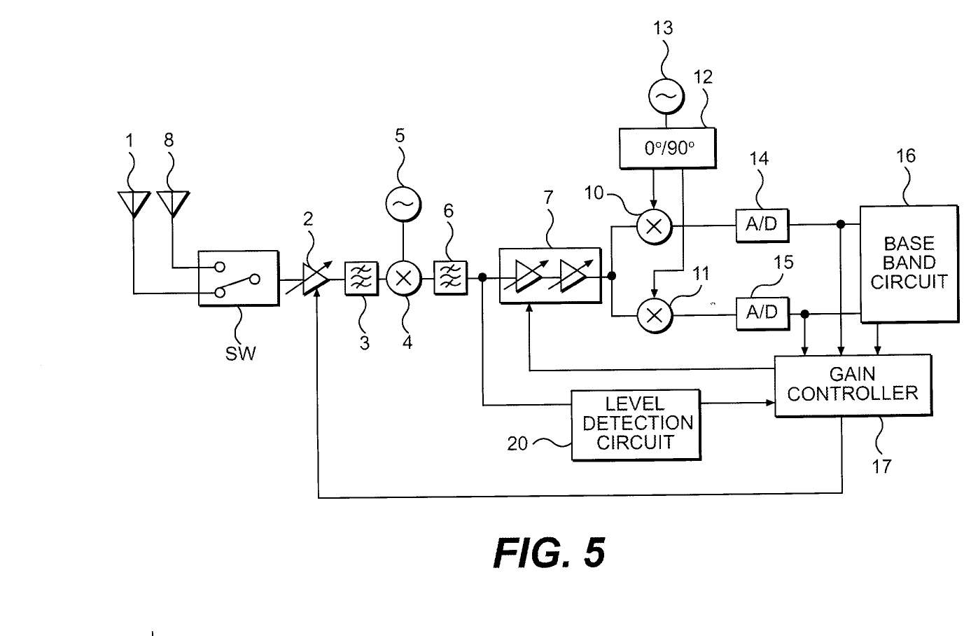

FIG. 5 shows a receiving apparatus according to a first embodiment of the present invention. A wireless wave received through an antenna 1 or an antenna 8 may be amplified by a low noise amplifier (LNA) 2, passed through a band pass filter (BPF) 3, and then converted into an IF signal by a down converter (DC) 4. At the BPF 3, unnecessary noise contained in the received wireless wave is removed.

For example, considering a wireless LAN system, a wireless wave of a 2.4 GHz band is used for a system compliant with IEEE802.11b, and a wireless wave of a 5 GHz band is used for a system compliant with IEEE802.11a. Frequencies of these wireless waves are converted into about 500 MHz by the DC (or mixer) 4. A 1st local frequency oscillator 5 generates an antenna input frequency f of 0±500 MHz so as to set an output signal of the DC 4 to 500 MHz. Thus, the BPF 3 becomes a filter mainly for the 2.4 GHz or 5 GHz band, and a BPF 6 becomes a filter mainly for the 500 MHz band.

The BPF 6 may be called a channel selection filter because of a role thereof to remove an adjacent channel signal. An output signal of the BPF 6 is inputted to an AGC amplifier 7. At the AGC amplifier 7, a gain is controlled to maintain a signal waveform in a linear shape. Output signals of the AGC amplifier 7 are passed through an orthogonal demodulation circuit constituted of mixers 10 and 11, a 90° phase shifter 12, and a 2nd local oscillator 13, accordingly becoming I and Q signals orthogonal to each other.

The I and Q signals are maintained in linear shapes by controlling a gain of the AGC amplifier 7. For example, in the wireless LAN system, a dynamic range necessary for receiving a wireless wave is about 80 dB. If attenuation of the LNA 2 is 20 dB, then the gain of the AGC amplifier 7 needs a variable range of about 60 dB.

The I and Q signals are converted into digital signals respectively by AD converters 14 and 15, and processed by a base band circuit 16. In order to control the gain of the AGC amplifier 7, it is necessary to know a received electric field strength. A gain controller 17 controls gains of the LNA 2 and the AGC amplifier 7. The gain of the AGC amplifier 7 is fixed in an initial state. In a normal state, however, it is controlled according to sensitivity of the wireless LAN system.

A difference of one embodiment of the receiving apparatus from the conventional receiving apparatus (FIG. 5) is the presence of a level detection circuit 20 for detecting a level of a received signal inputted to the AGC amplifier 7. A feature of the level detection circuit 20 is a function provided to detect signal strengths of optional two or more levels.

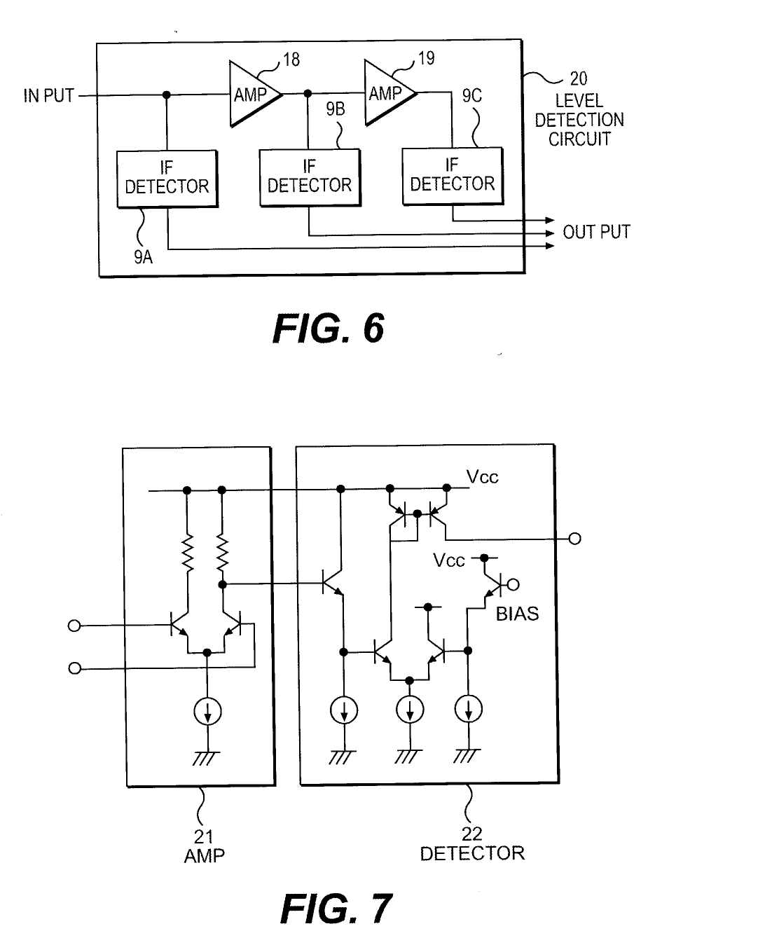

FIG. 6 shows an example of the level detection circuit of FIG. 5. The embodiment is described by way of example, where the level detection circuit 20 is provided with a function of comparing a strength (level) of a received signal with optional three levels, and determining a range of the strength of the received signal immediately after a start of receiving.

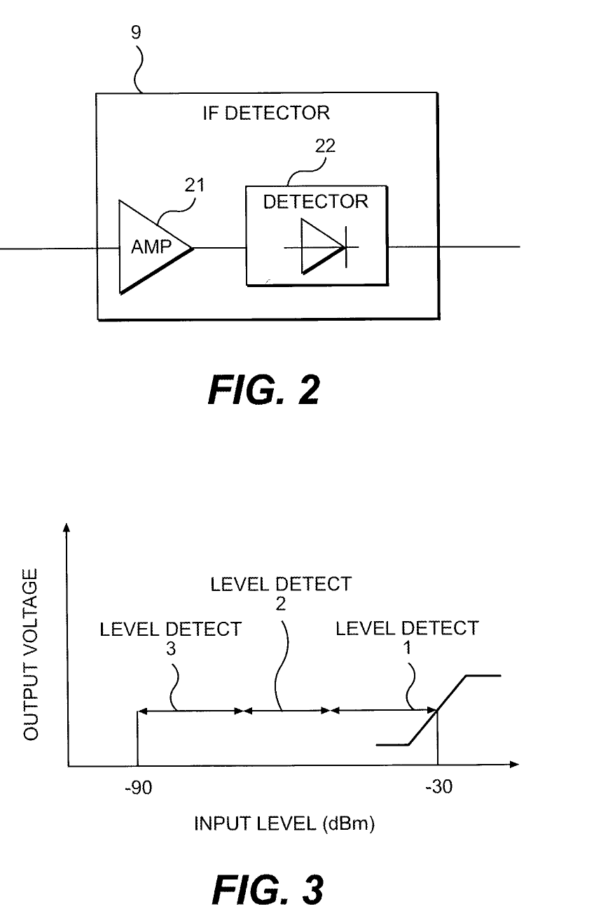

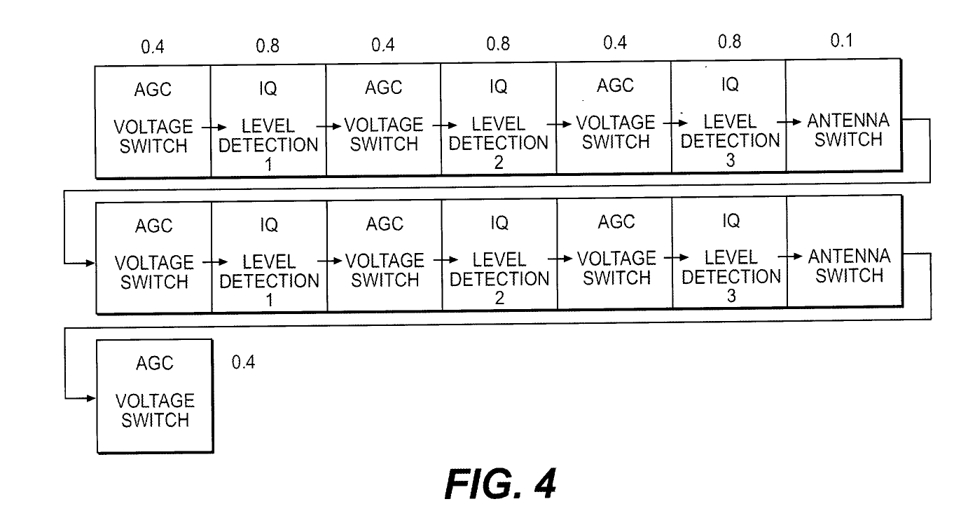

The level detection circuit 20 according to one embodiment of the present invention includes three IF detectors 9A, 9B and 9C, and two amplifiers 18 and 19. Each of the IF detectors 9A, 9B and 9C may be similar in configuration to, for example, the IF detector 9 of FIG. 2. Each of the IF detectors 9A, 9B and 9C has a circuitry similar to, for example, that shown in FIG. 7.

In the embodiment of FIG. 6, output signal of the BPF 6 of FIG. 5 becomes an input signal of the level detection circuit 20, and inputted to the IF detector 9A. In addition, the output signal of the BPF 6 of FIG. 5 is inputted through the amplifier 18 to the IF detector 9B, and through the amplifiers 18 and 19 to the IF detector 9C. In this embodiment, output signals of the IF detectors 9A, 9B and 9C are inputted to the gain controller 17.

The output signals of the IF detectors 9A, 9B and 9C may be analog or digital signals. When the output signals of the IF detectors 9A, 9B and 9C are analog signals, analog/digital conversion may be carried out by using a comparator at an input unit of the gain controller 17. When the output signals of the IF detectors 9A, 9B and 9C are digital signals, a comparator may be disposed in an output unit of each of the IF detectors 9A, 9B and 9C to carry out analog/digital conversion.

The IF detector 9A has a circuitry for outputting a level detected output signal, for example when the strength of the received wireless wave (antenna input level) is −30 dBm or higher. Each of the amplifiers 18 and 19 may have a gain of 20 dB, for example.

The IF detectors 9A, 9B and 9C may be similar to one another in performance. Thus, the IF detector 9A outputs a level detected signal when the strength of the received wireless wave is equal to/higher than −30 dBm, the IF detector 9B outputs a level detected signal when the strength of the received wireless wave is equal to/higher than −50 dBm, and the IF detector 9C outputs a level detected signal when the strength of the received wireless wave is equal to/higher than −70 dBm.

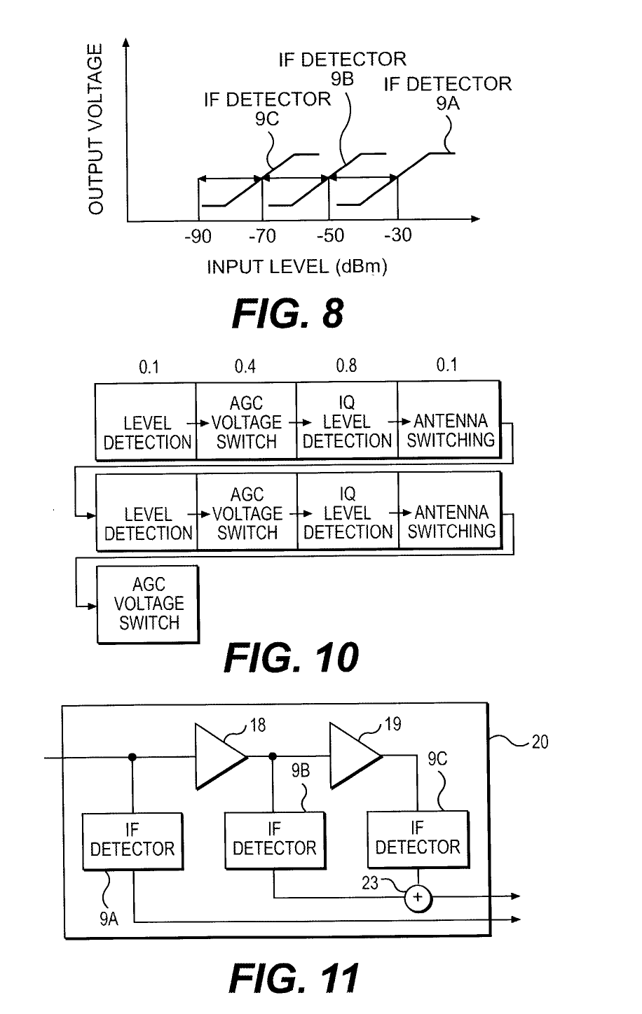

The above-described situation is shown in FIG. 8. In this example, the output signals (output voltages) of the IF detectors 9A, 9B and 9C are directly transferred as analog signals to the gain controller 17, and converted into digital signals by using the comparator at the input unit of the gain controller 17 (determination of “0” or “1”). As described above, however, at the IF detectors 9A, 9B and 9C, the level detected signals (level detected voltages) of FIG. 8 may be converted into digital signals by using the comparators.

Accordingly, the IF detectors 9A, 9B and 9C may operate in the following manner. That is, (1) when the strength of the received wireless wave is −30 dBm or higher, all the IF detectors 9A, 9B and 9C output level detected signals, (2) when the strength of the received wireless wave is ≧−50 dBm to <−30 dBm, the IF detectors 9B and 9C output level detected signals, while the IF detector 9A outputs no level detected signals. (3) When the strength of the received wireless wave is ≧−70 dBm to <−50 dBm, only the IF detector 9C outputs a level detected signal, while the IF detectors 9A and 9B output no level detected signals, and (4) when the strength of the received wireless wave is <−70 dBm, none of the IF detectors 9A, 9B and 9C output level detected signals.

That is, electric field strengths of wireless waves inputted to the antennas 1 and 8 (i.e.input levels of AGC amplifier 7) are compared with three reference levels of the level detection circuit 20, and the output signals of the three IF detectors 9A, 9B and 9C are detected, thus making it possible to set the strength of each wireless wave immediately after the start of receiving.

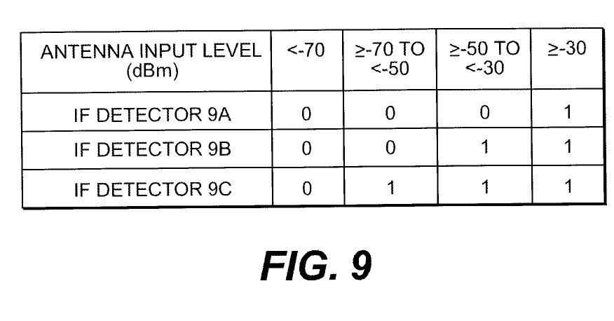

If “1” is set to indicate that the IF detectors 9A, 9B and 9C output the level detected signal, and “0” is set to indicate that they do not output the level detected signals, then a relation between the antenna input level and the output signal of each of the IF detectors 9A, 9B and 9C becomes as shown in FIG. 9.

Therefore, immediately after an initial synchronizing signal defined in the system of IEEE802.11a is received, it is possible to know which area of FIG.9 an antenna input level is in. The time from inputting of the received signals to the IF detectors 9A, 9B and 9C to outputting of the level detected signals is may be about 0.1 μs, though some portions may be dependent on load resistors and load capacitors.

The AD converters 14 and 15 may be 8-bit and, as described above, substantial dynamic ranges thereof are about 28 dB. Thus, as shown in FIG.9, if each range of the antenna input levels partitioned by the level detection circuit 20 is 20 dB, this should be enough for the receiving apparatus to be compliant with IEEE802.11a.

A gain of the AGC amplifier 7 in an initial state may be set to a value (GA2) capable of receiving signals (received wireless waves) inputted to the antennas 1 and 8 when strengths thereof are equal to/higher than −90 dBm.

In this initiate state, for example if a wireless wave of below −70 dBm is inputted, a range of the strengths of the received wireless waves is set in a range of 20 dB, which is from ≧−90 dBm to <−70 dBm. Accordingly, even without changing the initial state of the gain of the AGC amplifier 7, output voltages of the mixers 10 and 11 are set in a range of 28 dB, which can be received by the AD converters 14 and 15 of a rear stage thereof.

At this time, the output signals of the IF detectors 9A, 9B and 9C are all set to “0”. Thus, in this case, without changing the gain of the AGC amplifier 7, demodulation outputs are sent to the AD converters 14 and 15, and the output signals of the AD converters 14 and 15 are read by the gain controller 17. Accordingly, an accurate level of the received signal is determined, and it is possible to set a final gain of the AGC amplifier 7.

The gain of the AGC amplifier 7 is normally controlled in such a way as to maintain the level of signals outputted from the mixers 10 and 11 at constant values. Assuming that a range of input levels of the AD converters 14 and 15 is from 0 to 1V, maximum amplitude of each of the output signals of the mixers 10 and 11 is set to be about 0.5V.

In this embodiment, input levels (strengths of received wireless waves) of the antennas 1 and 8 are ≧−70 dBm to <−50 dBm, as apparent from FIG.9, the IF detectors 9A and 9B output “0”, while the IF detector 9C outputs “0”. Simultaneously with reception of output signals of the IF detectors 9A, 9B and 9C, the gain controller 17 may change an AGC voltage so as to reduce the gain of the AGC amplifier 7 by 20 dB (gain of AGC amplifier 7 becoming “GA2-20”).

In this embodiment, the input levels (strengths of received wireless waves) of the antennas 1 and 8 are ≧−50 dBm to <−30 dBm, as apparent from FIG.9, the IF detector 9A outputs “0”, while the IF detectors 9B and 9C output “0”. Simultaneously with reception of output signals of the IF detectors 9A, 9B and 9C, the gain controller 17 may change an AGC voltage so as to reduce the gain of the AGC amplifier 7 by 40 dB (gain of AGC amplifier 7 becoming “GA2-40”).

In this embodiment, the input levels (strengths of received wireless waves) of the antennas 1 and 8 are ≧−30 dBm, as apparent from FIG.9, all the IF detectors 9A, 9B and 9C output “0”. Simultaneously with reception of output signals of the IF detectors 9A, 9B and 9C, the gain controller 17 may change an AGC voltage so as to reduce the gain of the AGC amplifier 7 by 40 dB (gain of AGC amplifier 7 becoming “GA2-40”). In addition, simultaneously, the gain controller 17 reduces a gain of the LNA 2 by 20 dB (gain of LNA 2 becoming “GA1-20”) to avoid saturation of an output signal of the LNA 2.

Accordingly, the voltages outputted from the mixers 10 and 11 are set in a range of input levels receivable by the AD converters 14 and 15. An operation thereafter is similar to the foregoing.

In a system compliant with IEEE802.11a, as long as a transmitter and a receiver are not extremely close to each other, the levels of the signals (strengths of received wireless waves) inputted to the antennas 1 and 8 are not set equal to/higher than −10 dBm. Thus, 20 dB may be employed as a range of reduction for the gain of the LNA 2.

However, levels of signals inputted to the antennas 1 and 2 may be set, though seldom, equal to/higher than −10 dBm. In a corresponding relation, for example if a receiver can receive a signal of 0 dBm at a maximum, then a range of reduction for the gain of the LNA 2 is set to 30 dB. In this example, however, according to specifications of the receiver, the strength of a receivable signal is set below −10 dBm, and reception of a wireless wave of −10 dBm or higher will not be assumed.

FIG. 10 is a timing chart of the above-described operations. In the timing chart, first, an electric field strength of a wireless wave received by the antenna 1 is measured. For example, for the received signal, level detection is carried out, and then an AGC voltage is switched. In addition, the antenna is switched after IQ levels are detected. Then, an electric field strength of a wireless wave received by the antenna 8 is measured. For example, for the received signal, level detection is carried out, and then an AGC voltage is switched. In addition, after IQ levels are detected, a gain of the AGC amplifier 7 is set based on the electric field strengths of the wireless waves received by the antennas 1 and 8.

In the embodiment, the three levels are set in the level detection circuit 20. However, the number of levels set in the level detection circuit 20 can be set to two, for example by using a 10-bit AD converter.

As described above, according to the method consistent with the present invention, at least two levels are set, and substantially simultaneous detection is made whether the strength of the received wireless waves (actually, input signals of AGC amplifier 7) are at least equal to/higher than the two levels or below, whereby it is possible to quickly specify the range of the strengths of the received wireless waves.

That is, in the conventional method (FIG. 2), during specifying of the range of the strengths of the received wireless waves, the gain of the AGC amplifier was changed (AGC voltage was switched) a plurality of times, and the strengths of the received wireless waves (input signals of the AGC amplifier 7) were detected (IQ levels were detected) each time. Consequently, it has taken time to specify the range of the strengths of the received wireless waves.

In a method consistent with the present invention (FIG. 5), the level detection circuit is provided with the function of detecting at least two levels, and the strengths of the received wireless waves (input signals of AGC amplifier) are detected in the level detection circuit. Thus, during specifying of the range of the strengths of the received wireless waves, the gain of the AGC amplifier is not changed (constant), and detection of the strengths of the received wireless waves (level detection) may be carried out only once.

Therefore, according to the method of the present invention, time necessary for setting the gain of the AGC amplifier may be 3.2 μs at a maximum, which is within 4 μs as a target. In this case, it is assumed that time necessary for each of level detection and antenna switching is 0.1 μs, time for AGC voltage switching (setting) 0.4 μs, and time for IQ level detection 0.8 μs.

However, since the synchronizing signal of IEEE802.11a contains an AM component, the signals outputted from the IF detectors 9A, 9B and 9C also contain AM components. Accordingly, by using a comparator having hysteresis, determination is made as to the values (“0” or “1”) of the output signals of the IF detectors 9A, 9B and 9C.

As described above, the receiving apparatus of the present invention controls the gain of the AGC amplifier so as to prevent the received signal from being distorted, and the level detection circuit for detecting the level of the received signal inputted to the AGC amplifier is provided with the function of detecting the signal strengths of optional two levels or more. In this case, because the range of the preset level of the strength of the received signal is set in can be determined immediately after the start of receiving, it is possible to quickly set the gain of the AGC amplifier. In addition, the system compliant with IEEE802.11a can be provided.

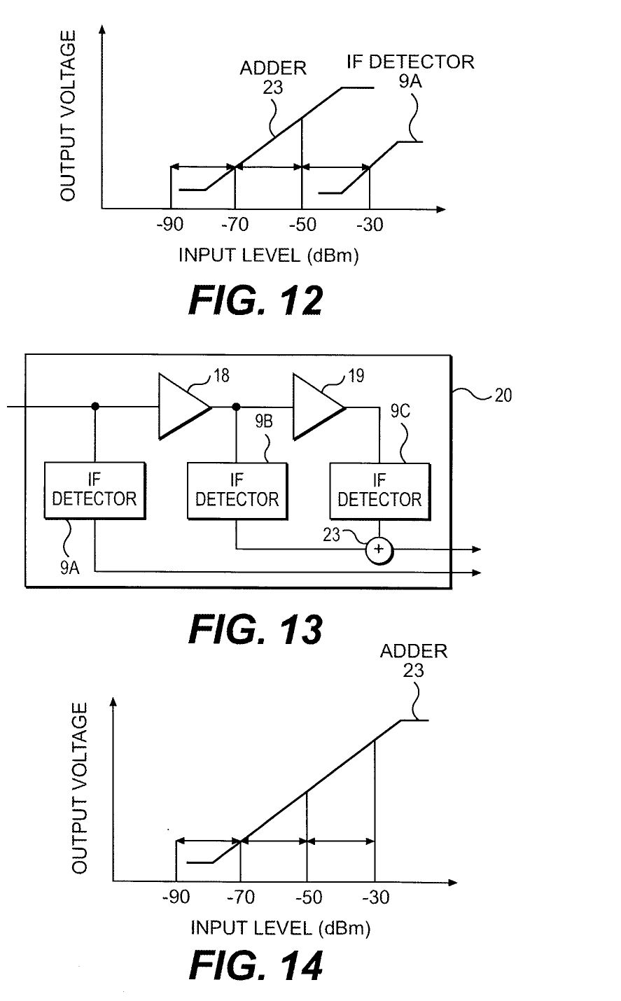

FIG. 11 shows a part of a receiving apparatus according to a second embodiment of the present invention. An entire configuration of the receiving apparatus can be shown in FIG. 5 as in the case of the receiving apparatus of the first embodiment. As compared with the receiving apparatus according to the first embodiment, a feature of the receiving apparatus of the present embodiment is that a level detection circuit 20 includes an adder 23. That is, the adder 23 adds together output signals of IF detectors 9B and 9C. In this case, output signals of an IF detector 9A and the adder 23 become respectively as shown in FIG. 12.

In a relation between an antenna input level and an output voltage of the adder 23, threshold values are set in totally two places, i.e., places where antenna input levels become −70 dBm and −50 dBm, and comparison is executed. In this way, since a lastly obtained digitized signal becomes similar to that of the first embodiment, processing thereafter is also similar to that of the first embodiment.

However, since an output range of the adder 23 is wider than that of each IF detector of the first embodiment, a threshold value for level detection can be optionally selected. For example, assuming that AD converters 14 and 15 are 10-bit-types, substantial dynamic ranges thereof become about 30 dB. In this case, threshold values for input levels of antennas 1 and 8 can be set in places of −60 dBm and −30 dBm.

As described above, detection of two levels is enough in the case of the 10-bit AD converter, while three levels may be detected in the case of an 8-bit AD converter.

According to the second embodiment of the present invention, since the output signals of IF detectors 9B and 9C are added by adder 23, and then outputted to gain controller 17, it is possible to optionally set a range of level detection from −70 dBm to −50 dBm. As a result, even when the dynamic ranges of the AD converters 14 and 15 are changed, the range of level detection can be changed. Gain controller 17 arranges the gain of AGC amplifier 7 depend on the outputted signal from adder 23. It is also possible that outputted signal from adder 23 is supplied to gain controller 17 via AD converter and gain controller 17 arranges the gain of AGC amplifier 7 depend on the outputted signal from adder 23 via AD converter.

FIG. 13 shows a receiving apparatus according to a third embodiment of the present invention. The receiving apparatus of the present embodiment is a modified example of the receiving apparatus of the second embodiment. Its feature is that, in a level detection circuit 20, an adder 23 is provided to add together output signals of all IF detectors 9A, 9B and 9C.

The addition of the output signals of all the IF detectors 9A, 9B and 9C enables an output characteristic as shown in FIG. 14 to be obtained. In the relation of FIG. 14, if threshold values for input signal levels are set at points of −70 dBm, −50 dBm and −30 dBm, and comparison is executed thereamong, then a lastly obtained digitized signal is set similar to that of the first embodiment.

In such a manner, as compared with the second embodiment, a range of level detection can be selected more freely. In addition, a tolerance can be provided for design of the receiving apparatus with respect to the dynamic ranges of the AD converters 14 and 15.

However, in this embodiment, since output response time of the adder 23 is longer as compared with the second embodiment, it takes longer to reach level detection, and high accuracy may be necessary for a detection voltage for the level detection.

As described above, the receiving apparatus consistent with the present invention includes the AGC amplifier to perform gain control for preventing distortion of a received signal, and at least the two signal strength detection circuits (IF detectors). Thus, it is possible to quickly specify a range of strengths of received signals. Therefore, when a dynamic range of the AD converter is smaller than an original dynamic range to be received, it is possible to specify a gain control range of the AGC amplifier without reading the strengths of the received signals in the AD converter. As a result, time necessary for setting a gain of the AGC amplifier can be greatly shortened.

In addition, when at least three signal strength detection circuits may be present, output signals of at least two of the detection circuits are analog-added. The addition widens a dynamic range of signal strength detection outputs, and enables a range of signal strength detection to be set freely. Thus, it is possible to perform setting according to a dynamic range of the AD converter in the receiving apparatus.

Furthermore, when at least three signal strength detection circuits are present, output signals of all the detection circuits may be analog-added. Thus, no limits are imposed on a range of signal strength detection, thus making it possible to deal with all kinds of receiving apparatuses. The scope of the invention is defined by the claims and one of ordinary skilled in the art realize that.

What is claimed is:

1. A receiving apparatus comprising:
a gain control amplifier;
a gain controller to control a gain of the gain control amplifier; and
a level detection circuit to specify a range of strengths of received signals based on a signal coupled to an input of the gain control amplifier,
wherein the gain controller controls the gain of the gain control amplifier based on the range of the strengths of the received signals.

2. The receiving apparatus according to claim 1, wherein the level detection circuit detects whether a strength of the input signal is grater than or less than first and second levels.

3. The receiving apparatus according to claim 1, wherein the level detection circuit detects which of first, second and third ranges the strength of the input signal belongs to.

4. The receiving apparatus according to claim 1, wherein the level detection circuit further comprising;
a first IF detector to receive the input signal and detect whether the strength of the input signal is greater or less than a fixed level;
a first amplifier for receiving the input signal, the first amplifier having a first gain; and
a second IF detector to receive an output signal of the first amplifier and to detect whether a strength of the output signal of the first amplifier is greater than or less than the fixed level.

5. The receiving apparatus according to claim 4, wherein the level detection circuit further comprising;
a second amplifier having a second gain to receive the output signal of the first amplifier; and
a third IF detector to receive an output signal of the second amplifier and to detect whether a strength of the output signal of the second amplifier is greater than or less than the fixed level.

6. The receiving apparatus according to claim 5, wherein said level detection circuit includes an adder for to add two of output signals of the first, second and third IF detectors.

7. The receiving apparatus according to claim 5, wherein said level detection circuit includes an adder to add all of output signals of the first, second and third IF detectors.

8. The receiving apparatus according to claim 5, wherein said level detection circuit includes a comparator for converting the output signals of the first, second and third IF detectors into digital signals.

9. The receiving apparatus according to claim 5, wherein said gain controller includes the comparator for converting the output signals of the first, second and third IF detectors into the digital signals.

10. The receiving apparatus according to claim 1, wherein setting of a gain of the gain control amplifier is terminated within 4 μs.

11. The receiving apparatus according to claim 1, further comprising:
an orthogonal demodulation circuit for receiving an output signal of the gain control amplifier and outputting I and Q signals orthogonal to each other;
a first AD converter for subjecting the I signal to analog/digital conversion; and
a second AD converter for subjecting the Q signal to analog/digital conversion,
wherein the gain controller controls the gain of the gain control amplifier to set input signals of the first and second AD converters within dynamic ranges thereof.

12. The receiving apparatus according to claim 11, further comprising:
a low noise amplifier for receiving the received signal; a first filter for receiving an output signal of the low noise amplifier;
a mixer for receiving an output signal of the first filter; and a second filter for receiving an output signal of the mixer,
wherein an output signal of the second filter is inputted to the gain control amplifier.

13. The receiving apparatus according to claim 11, wherein the dynamic ranges of the first and second AD converters are narrower than a total of variable widths of gains of the low noise amplifier and the gain control amplifier.

14. A wireless LAN card comprising;
an antenna to receive signals;
a receiving apparatus, the receiving apparatus further comprising;
a gain control amplifier;
a gain controller to control a gain of the gain control amplifier; and
a level detection circuit for to specify a range of strengths of received signals based on an signal coupled to an input signal of the gain control amplifier,
wherein the gain controller controls the gain of the gain control amplifier based on the range of the strengths of the received signals.

15. The wireless LAN card according to claim 14, wherein the level detection circuit detect whether a strength of the input signal is greater than or less than first and second level.

16. The wireless LAN card according to claim 14, wherein the level detection circuit detect which of first, second and third ranges the strength of the input signal belongs to.

17. The wireless LAN card according to claim 14, wherein the level detection circuit further comprising;
a first IF detector to receive the input signal and to detect whether the strength of the input signal is greater than or less than a fixed level or below,
a first amplifier to receive the input signal, the first amplifier having a first gain; and
a second IF detector to receive an output signal of the first amplifier and to detect whether a strength of the output signal of the first amplifier is greater than or less than the fixed level.

18. A receiving method comprising:
controlling a gain of the gain control amplifier; and
specifying a range of strengths of received signals based on a signal coupled to an input of the gain control amplifier,
wherein the controlling the gain of the gain control amplifier based on the range of the strengths of received signals.

19. A receiving method comprising:
controlling a gain of the gain control amplifier;
specifying a range of strengths of received signals by detecting whether strengths of the input signals of a gain control amplifier are greater than or less than a first level and second level.; and
where in the controlling the gain of the based on the range of the strengths of received signals.

20. The receiving method according to claim 19, wherein, during the specifying of the range of the strengths of the received signals, the gain of the gain control amplifier is constant.

21. The receiving method according to claim 19, wherein, after the specifying of the range of the strengths of the received signals, the gain of the gain control amplifier is adjusted.

22. The receiving method according to claim 19, wherein the range of the strengths of the received signals is specified by detecting whether the strengths of the input signals of the gain control amplifier are equal to/higher than a fixed level or below, and by detecting whether strengths of signals obtained by amplifying the input signals of the gain control amplifier are greater than of less than the fixed level.
